(19) United States
(12) Patent Application Publication
(10) Pub. No.: US 2008/0005403 A1
(43) Pub. Date: Jan. 3, 2008

(54) OVERCOMING COMPILATION BUFFER OVERLOADS IN VIRTUAL MACHINES

(75) Inventor: Cristiano Di Flora, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, ESPOO (FI)

(21) Appl. No.: 11/427,586

(22) Filed: Jun. 29, 2006

(51) Int. Cl. G06F 3/00

(52) U.S. Cl. 710/56

(57) ABSTRACT

Apparatuses and methods that allow a virtual machine on a device to overcome method cache overloads in dynamic just-in-time (JIT) compilation are disclosed. The apparatuses and methods dynamically adjust the size of a buffer caching compiled native code according to the effective run-time behavior of running applications on the device. Modules in the device monitor the method calls associated with the buffer to detect non-performance-critical and performance-critical overload conditions. The size of the buffer is increase, decreased, or not changed accordingly.

### FIELD OF THE INVENTION

This invention relates generally to compiler area management. More particularly, aspects of the invention relate to apparatuses and methods for enhancing compiler buffer management.

### BACKGROUND OF THE INVENTION

Virtual machines may circumvent bytecode interpretation overhead using a dynamic compilation technique called just-in-time (JIT) compilation. JIT compilers translate bytecode into native machine code. The compiled native machine code is stored in a static, predefined memory area (e.g., compiler area) that is allocated before runtime. This static memory area is sometimes referred to as a buffer or a cache.

Mobile terminals have limited memory resources. Mobile terminals and memory-constrained devices running applications using a virtual machine with JIT compilers have many shortcomings. For example, memory is wasted if the buffer size is designated as large because it effectively prevents other applications from running simultaneously on the device. In another example, if the buffer size is designated too small, then the device faces congestion and overload. Again, resulting in inefficient operation and/or an unusable application.

Therefore, there is a need in the art for a system and method for better managing a compiler buffer.

### SUMMARY OF THE INVENTION

The following represents a simplified summary of some embodiments of the invention in order to provide a basic understanding of various aspects of the invention. This summary is not an extensive overview of the invention. It is not intended to identify key or critical elements of the invention or to delineate the scope of the invention. Its sole purpose is to present some embodiments of the invention in simplified form as a prelude to the more detailed description that is presented below.

In order to overcome the aforementioned deficiencies in the prior art and other problems that will become apparent after reading this disclosure, various aspects of the present invention provide systems, methods, and devices for adjusting the size of a buffer in a compiler memory area.

In one embodiment, an apparatus configured to dynamically adjust the size of a buffer is disclosed. The apparatus comprises a processor and memory unit comprising numerous modules: compiler module, buffer monitor module, overload detector module, and buffer shaper module. The compiler module comprises a buffer for storing native machine code for methods/functions translated from bytecode format. The buffer shaper module uses input from the other modules to increase, decrease, or leave unchanged the size of the buffer in the compiler device. The overload detector module uses an alpha-count mechanism to detect the type of overload condition in the compiler module.

In another embodiment, a method is disclosed for adjusting the size of a buffer in a compiler module. The method comprises steps: monitoring particular method calls associated with the buffer; detecting the type of overload condition in the compiler module; generating an indication corresponding to the type of overload condition, and decreasing, increasing, or leaving unchanged the size of the buffer in response to the indication.

### BRIEF DESCRIPTION OF THE DRAWINGS

FIG. 1 shows an illustrative device in accordance with aspects of the invention.

FIG. 2 shows an illustrative flowchart of a method in accordance with aspects of the invention.

FIG. 3 shows an illustrative flowchart of a method in accordance with aspects of the invention.

FIG. 4 shows the contents of an illustrative buffer in accordance with aspects of the invention.

### DETAILED DESCRIPTION OF THE INVENTION

In one example in accordance with aspects of the invention, the apparatuses and methods disclosed allow a virtual machine on a device to overcome method cache overloads in dynamic just-in-time (JIT) compilation. The apparatuses and methods dynamically adapt the size of the compiled methods cache according to the effective run-time behavior of running applications on the device. These and other aspects of the invention are disclosed in detail below.

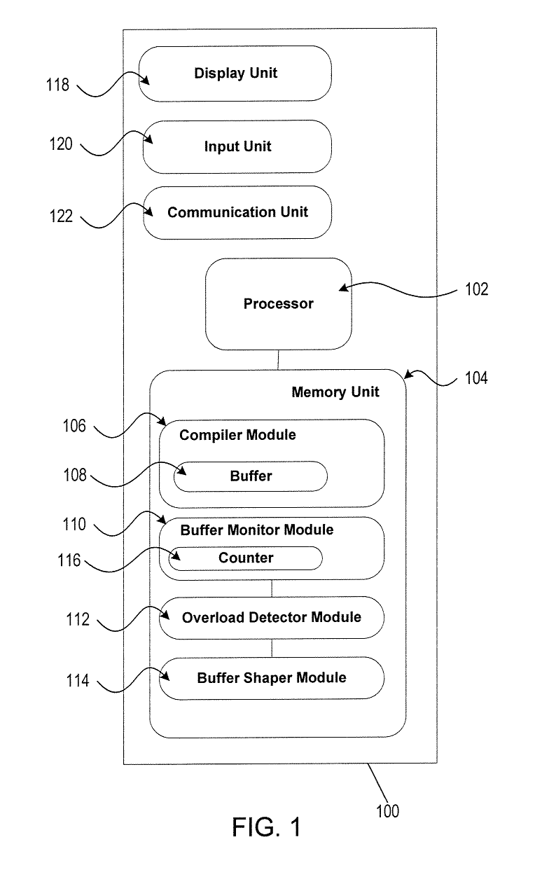

FIG. 1 depicts an illustrative device 100 in accordance with aspects of the invention. In a simplified configuration, device 100 typically includes a processor 102 (e.g., Intel microprocessor, ARM processor, integrated circuit (IC), special-purpose processor, etc.) coupled to a memory unit 104. Depending on the exact configuration and type of computing device, the memory unit 104 may be comprised of volatile memory (e.g., RAM), non-volatile memory (e.g., ROM, flash memory, etc.) or a combination of the two. In addition, the device 100 may also have additional features and/or functionality. For example, device 100 may include additional storage (removable and/or non-removable) including, but not limited to, a media card memory slot, a display unit 118 (e.g., LCD screen, etc.), an input unit 120 (e.g., keyboard, keypad, etc.), and a communication unit 122 (e.g., antenna, Bluetooth, infrared, IEEE 802.11(b), etc.). In one example, the device 100 may be located in a mobile terminal, such as a cellular telephone, personal digital assistant (PDA), or other handheld computing device.

Furthermore, aspects of the invention may be described in the general context of computer-executable instructions, such as modules, being executed by the processor 102 of the device 100. Generally, modules may include routines, programs, objects, components, data structures, etc., that perform particular tasks or implement particular abstract data types. The memory unit 104 may be comprised of: compiler module 106 including a buffer 108; buffer monitor module 110 including a counter 116; overload detector module 112; and buffer shaper module 114.

In one example, the compiler module 106 includes a just-in-time (JIT) compiler. A JIT compiler is a platform-specific compiler that generates native machine code from bytecode. For example, Java executable programs in bytecode format may be comprised of methods. The bytecode may be provided to a Java virtual machine residing in the memory unit 104 of a device 100. The Java virtual machine may be embedded with a JIT compiler for dynamic compilation of the bytecode. The JIT compiler may compile (e.g., translate) the bytecode into native machine code executable by the processor 102.

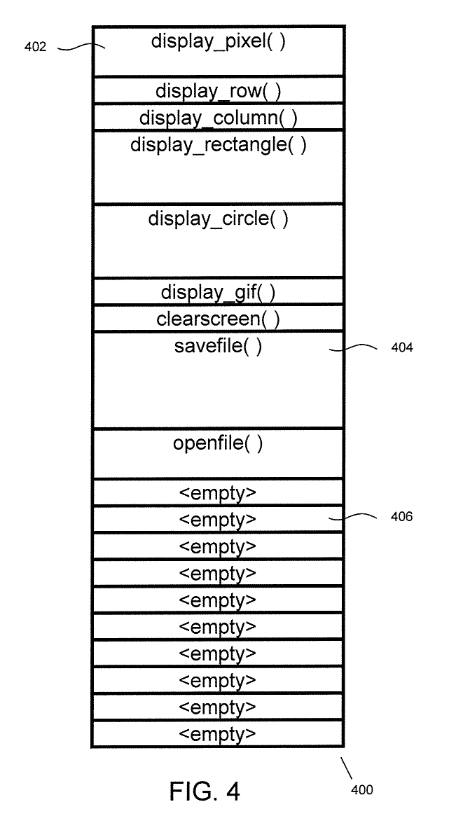

The native code corresponding to each method in the Java executable program may be cached in a buffer 108 (e.g., a method-compilation cache) in the compiler module 106. A depiction of the contents of an illustrative method-compilation cache in the buffer 108 is shown in FIG. 4, which will be discussed in greater detail later. In one example, at least part of the buffer 108 is stored in a dynamic heap memory in the memory unit 104. The size of the buffer 108 is increased and decreased in the dynamic heap memory area in accordance with various aspects of the invention. In some examples, the compiler module 106 may have a predetermined value set for the maximum buffer size to prevent the buffer 108 from consuming all the available heap memory. One skilled in the art will appreciate that the contents of the buffer 108 may be outside the control of a general-purpose garbage collection mechanism. Rather, the buffer 108 may use its own approach (e.g., least recently used (LRU), first-in-first-out (FIFO), etc.) to determine when to remove (e.g., erase, overwrite, etc.) an item from the buffer 108. Alternatively, the compiler module may have computer-executable instructions and/or logic for managing the contents of the buffer 108 in coordination with a general-purpose garbage collection mechanism.

The buffer monitor module 110 in the memory unit 104 is capable of monitoring for an overload condition in the compiler module 106. In one example, the buffer monitor module 110 intercepts particular method calls associated with the buffer 108. For example, a method call requesting to add the native code of a method to the buffer 108 (e.g., method-compilation cache) may be intercepted by the buffer monitor module 110. Similarly, a method call requesting to remove the native code of a method from the buffer 108 (e.g., method-compilation cache) may be intercepted by the buffer monitor module 110. One skilled in the art will appreciate that the buffer monitor module 110 can intercept particular method calls without affecting the usual operation of the compiler module. For example, the buffer monitor module 110 may simply receive a notification that a particular method call associated with the buffer 108 has been requested.

In accordance with aspects of the invention, the buffer monitor module 110 may be comprised of computer-executable instructions (e.g., firmware, software objects, etc.) and/or logic (e.g., multiplexers, demultiplexers, logic gates, etc.) for monitoring for an overload condition in the compiler module. For example, the buffer monitor module 110 may comprise a counter 116. A counter 116 may be a portion of memory (e.g., a register block) for storing one or more values. For example, a counter 116 may be incremented to keep count of the number of method calls requesting to add information to the buffer 108 (i.e., cache) over a particular period of time. Likewise, a counter 116 may be incremented to keep count of the number of method calls requesting to remove information from the buffer 108 (i.e., cache) over a particular period of time. In some examples, the counter 116 may store two values: one value counting the number of requests to add, and another value counting the number of requests to remove.

The buffer monitor module 110 may receive overload threshold values as an input. In accordance with aspects of the invention, one overload threshold value may correspond to method calls (e.g., the ObjectHeap::compiler_area_allocate_code method from Sun Microsystem's CLDC Hotspot VM implementation) requesting to add information to the buffer 108. Similarly, another overload threshold value may correspond to method calls (e.g., the CompiledMethodCache::Evict method from Sun Microsystem's CLDC Hotspot VM implementation) requesting to remove information from the buffer 108. Although aspects of the invention have been described using Sun Microsystem's CLDC (Connected Limited Device Configuration) Hotspot VM for illustrative purposes, one skilled in the art will appreciate that various aspects of the invention may be embodied using CDC (Connected Device Configuration) and other configurations known to those of skill in the art.

For example, the buffer monitor module 110 may identify an overload condition if the counter value corresponding to requests for adding information to the buffer 108 has a greater value than the corresponding overload threshold value inputted. Likewise, the buffer monitor module 110 may identify an overload condition if the counter value corresponding to requests for removing information from the buffer 108 has a greater value than the corresponding overload threshold value inputted. In another example, the buffer monitor module 110 may output an indication of an overload condition to the overload detector module 112 only if the counter value corresponding to both the request for adding information and the requests for removing information to/from the buffer 108 are outside their respective overload threshold values. The indication outputted may equal binary ‘1’ if the compiler module is in an overload condition and may equal binary ‘0’ if the compiler module is not in an overload condition.

A compiler module in an overload condition may result in the inefficient execution of application code by a virtual machine (e.g., JIT compiler). An overload condition frequently occurs when the size of the buffer 108 is too small relative to its usage by the compiler module. The virtual machine adds native code in the buffer 108, and it also removes (e.g., overwrites) native code when the buffer becomes full. In situations where the virtual machine is repeatedly adding and removing information from the buffer 108, the computing device becomes inefficient (e.g., due to congestion). For example, a graphics-intensive application executing on a mobile terminal with limited memory resources may render the application unusable due to processor delays and insufficient frame rate. Rather, in accordance with aspects of the invention, various modules in the memory unit 104 of the device 100 may identify the overload condition, detect the type of overload condition (e.g., corresponding to transient congestion, permanent congestion, or no congestion) and react appropriately (e.g., increase buffer size, decrease buffer size, not change buffer size).

The indication outputted from the buffer monitor module 110 may be inputted into the overload detector module 112. The overload detector module 112 is capable of determining the type of overload condition occurring in the compiler module based at least in part on the indication inputted from the buffer monitor module 110. The overload detector module 112 may be comprised of computer-executable instructions (e.g., firmware, software objects, etc.) and/or logic (e.g., multiplexers, demultiplexers, logic gates, etc.) for determining the type of overload condition in the compiler module. Some examples of the types of overload conditions include, but are not limited to, a non-performance-critical overload condition, a performance-critical overload condition, and a no overload condition. A non-performance-critical overload condition is characterized by transient manifestation of overload-critical conditions. Meanwhile, a performance-critical overload condition represents permanent presence of overload-critical conditions. The overload detector module 112 is capable of distinguishing between different kinds of conditions by using any of numerous approaches, including but not limited to, count-and-threshold mechanisms (e.g., single threshold alpha-count mechanism, double threshold alpha-count mechanism, etc.). Numerous count-and-threshold mechanisms are known to those of ordinary skill in the art, therefore, each and every approach and variation on these approaches need not be expressly described here. The alpha-count mechanism in accordance with various aspects of the invention is illustrated in detail below.

In accordance with aspects of the invention, the overload detector module 112 generates an indication of the overload condition type and outputs the indication to the buffer shaper module 114. The overload detector module 112 outputs an indication of a non-performance-critical overload condition to the buffer shaper module 114 if the overload detector module detects a non-performance-critical overload condition. Meanwhile, the overload detector module 112 outputs an indication of a performance-critical overload condition to the buffer shaper module 114 if the overload detector module detects a performance-critical overload condition. Moreover, the overload detector module 112 may output an indication of a no overload condition to the buffer shaper module 114 if the overload detector module detects neither a performance-critical overload condition nor a non-performance-critical overload condition. One skilled in the art will appreciate that other overload conditions may be contemplated in accordance with aspects of the invention by one of ordinary skill in the art after review of the entirety disclosed herein.

Depending at least in part on the output from the overload detector module 112, the buffer shaper module 114 may dynamically adjust the size of the buffer 108 in the compiler module 106. The buffer shaper module 114 may be comprised of computer-executable instructions (e.g., firmware, software objects, etc.) and/or logic (e.g., multiplexers, demultiplexers, logic gates, etc.) for dynamically adjusting the size of the buffer 108. The buffer shaper module 114 may increase the size of the buffer 108 if the information (e.g., indication of overload condition type) from the overload detector module 112 indicates that a performance-critical overload condition exists. In contrast, the buffer shaper module 114 may decrease the size of the buffer 108 if the information (e.g., indication of overload condition type) from the overload detector module 112 indicates that a no overload condition (i.e., none of a performance-critical overload condition or a non-performance-critical overload condition) exists. Meanwhile, the buffer shaper module 114 may not change the size (i.e., the size of the buffer remains unchanged) of the buffer 108 if the information (e.g., indication of overload condition type) from the overload detector module 112 indicates that a non-performance-critical overload condition exists. In another example, the buffer shaper module 114 uses a maximum buffer size parameter to prevent the increase of the buffer 108 beyond a certain size. At least one benefit of a maximum buffer size parameter is the safeguard it provides the device 100 from a memory overflow error or similar fault.

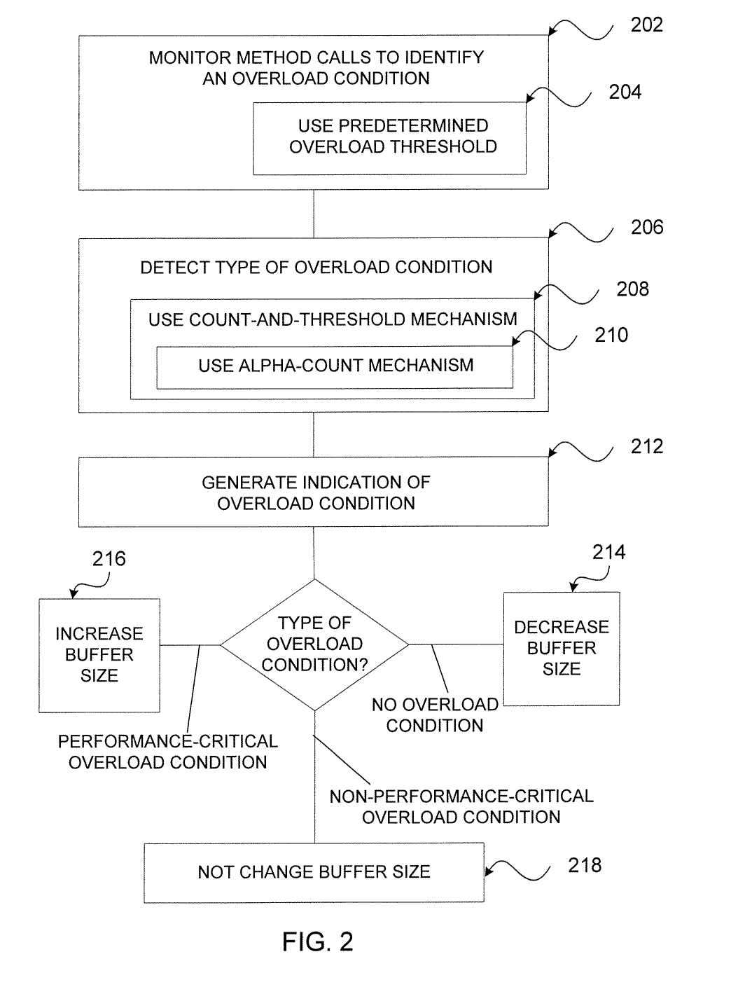

FIG. 2 is an illustrative flowchart of a method for adjusting the size of a buffer (e.g., a method-compilation cache) in accordance with aspects of the invention. In step 202, particular method calls associated with the buffer 108 and occurring over a particular period of time are monitored to identify an overload condition. Some examples of illustrative method calls monitored were provided earlier. For example, over a particular period of time lasting from a first time to a second time (e.g., 10 seconds), if the number of occurrences of the “compiler_area_allocate_code” method (i.e., a request to add information to the buffer 108) is twenty, but the predetermined overload threshold value corresponding to the particular type of method call (i.e., method calls that add information to the buffer 108) is fifteen, then the buffer 108 may be in a state of congestion (i.e., overload condition). Alternatively, in another example, only if both counter values (i.e., counter for method calls adding information and removing information) are greater than their corresponding predetermined overload threshold values (in step 204), then the buffer is in an overload condition. One skilled in the art will appreciate that method calls removing information also includes method calls that overwrite information or otherwise effectively remove information (e.g., by marking an item as deleted without physically erasing its information). In addition, a timer device (e.g., a clock) may be present in the buffer monitor module 110 for monitoring a particular period of time.

In step 206, the type of overload condition is detected (i.e., determined) using a count-and-threshold mechanism (in step 208) that is capable of detecting a plurality of types of overload conditions. Numerous count-and-threshold mechanisms are known to those of ordinary skill in the art, including the alpha-count mechanism. One example of the alpha-count mechanism in accordance with various aspects of the invention is illustrated in detail below. One skilled in the art will appreciate that many variations of this count-and-threshold mechanism exist and are considered to be contemplated in the disclosure herein.

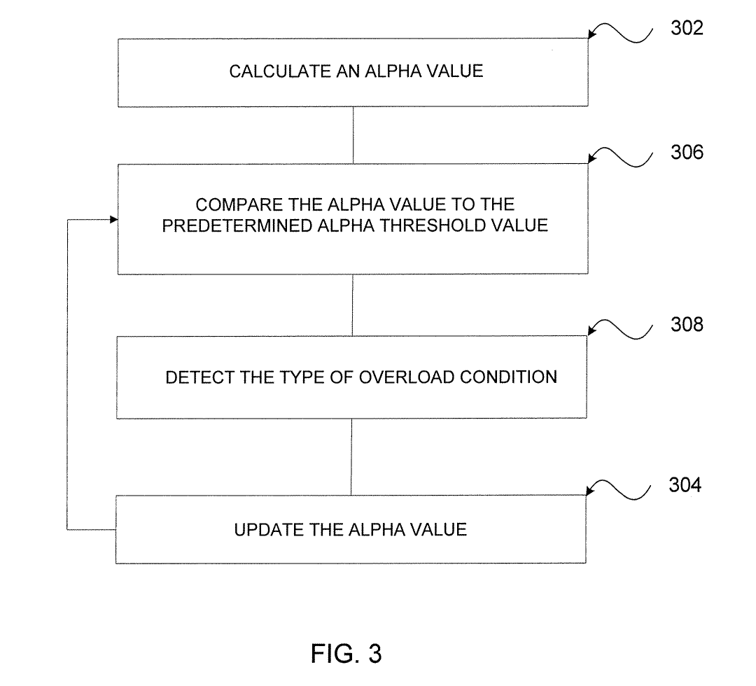

With reference to FIG. 3, in accordance with aspects of the invention, an alpha value (e.g., a first alpha value) is calculated (in step 302) for a first particular period of time. FIG. 3 shows an illustrative flowchart of various steps that may be executed by a processor programmed with or provided with computer-executable instructions in accordance with aspects of the invention. The alpha value (i.e., α(k)) is calculated in equation 1 according to the alpha-count mechanism below:

$$α ( k ) = \{ \begin{matrix}α ( k - 1 ) + 1 & if u ( k ) == 1 \\ α ( k - 1 ) - Δ & if ( u ( k ) == 0 ) ⋂ ( ( α ( k - 1 ) - Δ ) > 0 ) \\ 0 & if ( u ( k ) == 0 ) ⋂ ( ( α ( k - 1 ) - Δ ) <= 0 )\end{matrix} \qquad ( Equation 1 )$$

The alpha-count mechanism may be implemented using software modules and/or hardware logic. The u(k) in the above alpha-count mechanism corresponds to the indication of overload condition output from the buffer monitor module 110. As explained above, the indication outputted from the buffer monitor module 110 may equal binary ‘1’ if the compiler module is in an overload condition and may equal binary ‘0’ if the compiler module is not in an overload condition. Furthermore, “A” (i.e., delta) is a fixed parameter satisfying the constraint: 0<“Δ”<1. The alpha value may be increased by one upon indication of an overload condition (i.e., u(k)==1) and decreased by “A” (e.g., a value smaller than one) upon indication of no overload condition (i.e., u(k)==0). The alpha-count mechanism may be adjusted through the delta value to increase or decrease the rate at which an alpha threshold value is met or not met. For example, a high delta value may result in a faster recovery time because each indication of a no overload condition reduces the alpha value by more. One skilled in the art will appreciate that the alpha-count mechanism is well-known and beneficial for many reasons. At least one advantage of the alpha-count mechanism is its capability to discriminate between transient phenomena (e.g., non-performance critical overload condition) and persistent/permanent phenomena (e.g., performance critical overload condition).

In step 306, the current alpha value (e.g., a first alpha value) is compared to a predetermined alpha threshold value to detect (in step 308) the type of overload condition in the compiler module 106. Once the alpha threshold value is exceeded, the type of overload condition may be changed from transient (e.g., non-performance critical overload condition) to permanent (e.g., performance critical overload condition). A permanent overload condition corresponds to a state where the buffer monitor module persistently indicates an overload condition.

In step 304, an updated alpha value (e.g., a second alpha value) is calculated using the above alpha-count mechanism. Equation 1 above is used to calculate the updated alpha value based on the alpha value (e.g., the first alpha value) calculated earlier. As with the first alpha value calculated earlier, the updated alpha value (e.g., second alpha value) is compared (in step 306) to a predetermined alpha threshold value to detect (in step 308) the type of overload condition in the compiler module 106. For example, if the alpha value is zero, then an indication corresponding to a no overload condition is generated (in step 212) and outputted to the buffer shaper module 114 to decrease the buffer 108 size (in step 214). In another example, if the alpha value is equal to or above the predetermined alpha threshold value, then an indication corresponding to a performance-critical overload condition is generated (in step 212) and outputted to the buffer shaper module 114 to increase the buffer 108 size (in step 216). Otherwise, the buffer 108 size remains unchanged (in step 218).

One skilled in the art will recognize that the alpha-count mechanism may use an iterative process in calculating an updated alpha value. At least one benefit of the alpha-count mechanism, among other threshold-based heuristics, is its simpler mathematical representation, which makes its implementation more compact and easy. In addition, the computational complexity of this mechanism is relatively small, and thus it allows reducing the overhead that is inherent in some other mechanisms. One skilled in the art will appreciate that although the above example refers to a single-threshold alpha-count mechanism, a double-threshold alpha-count mechanism may also be used.

While it is understood that the invention may be implemented as a method, it may also be implemented in a computer readable medium having computer-executable instructions. Aspects of the invention may be implemented by way of software, hardware, or a combination thereof. Computer-readable media includes any available media that can be accessed by a processor in a computing device or system. Other features of the invention will become apparent from the detailed description when taken in conjunction with the drawings.

FIG. 4 is a depiction of the contents of an illustrative method-compilation cache 400 in the buffer 108 in the compiler module 106 in a device 100 in accordance with aspects of the invention. For example, A Java gaming application may contain many different graphical libraries with numerous methods (e.g., display_pixel( ), display_row( ), clearscreen( ), savefile( ), etc.). If a user of a device 100 attempts to run the application, the compiled native machine code for the executed methods (402 and 404) may be cached in a buffer 108 by a JIT compiler. In prior art systems, since the buffers size is fixed, if the application is active, then some methods may need to be frequently released and recompiled multiple times because there is not enough buffer memory (e.g., empty slot 406) to keep them in the cache. This overload condition may result in a large drop in the frame display rate that may in turn make the graphics application unusable. In accordance with aspects of the invention, the buffer monitor module 110 may send an indication of an overload condition to the overload detector module 112, which may send an indication to the buffer shaper module 114 to increase the size of the buffer 400 during runtime. In this example, the buffer 108 size may be adjusted (e.g., increased) at runtime according to application behavior. Thus, providing the user with a much more realistic and exciting game experience.

The present invention has sometimes been described in terms of preferred and illustrative embodiments thereof. Numerous other embodiments, modifications and variations within the scope and spirit of the appended claims will occur to persons of ordinary skill in the art from a review of this disclosure.

We claim:

1. A device configured to dynamically adjust size of a buffer, comprising:
a memory unit, comprising:
compiler module including a buffer;
buffer monitor module that monitors for an overload condition in the compiler module;
overload detector module that determines type of overload condition in the compiler module based at least in part on information from the buffer monitor module; and
buffer shaper module that dynamically adjusts size of the buffer in the compiler module based at least in part on information from the overload detector module; and
a processor coupled to the memory unit and programmed with at least the compiler module, the buffer monitor module, the overload detector module, and the buffer shaper module.

2. The device of claim 1, wherein the buffer monitor module outputs an indication of overload condition to the overload detector module, wherein the overload detector module outputs an indication of overload condition type to the buffer shaper module, and wherein overload threshold values are input into the buffer monitor module.

3. The device of claim 1, wherein the compiler module comprises a just-in-time compiler, and wherein at least part of the buffer is stored in a dynamic heap memory.

4. The device of claim 1, wherein the buffer monitor module comprises a counter, and wherein the buffer monitor module intercepts particular method calls associated with the buffer and increments the counter.

5. The device of claim 4, wherein the buffer comprises a method-compilation cache, and wherein the particular method calls intercepted by the buffer monitor module comprise a request to add a method to the method-compilation cache and a request to remove a method from the method-compilation cache.

6. The device of claim 1, wherein the overload detector module outputs an indication of a non-performance-critical overload condition to the buffer shaper module if the overload detector module detects a non-performance-critical overload condition, and wherein the overload detector module outputs an indication of a performance-critical overload condition to the buffer shaper module if the overload detector module detects a performance-critical overload condition.

7. The device of claim 1, wherein the overload detector module comprises a count-and-threshold mechanism that detects a non-performance-critical overload condition in the compiler module.

8. The device of claim 7, wherein the count-and-threshold mechanisms comprises an alpha-count mechanism.

9. The device of claim 1, wherein the size of the buffer in the compiler module is increased if the information from the overload detector module indicates a performance-critical overload condition in the compiler module.

10. The device of claim 1, wherein the size of the buffer in the compiler module is decreased if the information from the overload detector module indicates none of a performance-critical overload condition or a non-performance-critical overload condition in the compiler module.

11. The device of claim 1, wherein the device is located in a mobile terminal.

12. A method for adjusting size of a buffer in a compiler module, comprising:
(a) monitoring particular method calls associated with the buffer in the compiler module occurring over a particular period of time to identify an overload condition, wherein the particular method calls monitored comprise a request to add information to the buffer and a request to remove information from the buffer;
(b) detecting a type of overload condition in the compiler module using a count-and-threshold mechanism that is capable of detecting a plurality of types of overload conditions, wherein the types of overload conditions comprise a non-performance-critical overload condition, a performance-critical overload condition, and a no overload condition;
(c) generating an indication corresponding to the type of overload condition in the compiler module; and
(d) decreasing size of the buffer if the indication corresponds to the no overload condition.

13. The method of claim 12, comprising:
(e) increasing size of the buffer if the indication corresponds to the performance-critical overload condition; and
(f) not changing size of the buffer if the indication corresponds to the non-performance-critical overload condition.

14. The method of claim 12, wherein (a) uses a predetermined overload threshold value to identify an overload condition.

15. The method of claim 12, wherein the count-and-threshold mechanism comprises an alpha-count mechanism using a predetermined alpha threshold value.

16. The method of claim 15, wherein (b) comprises:
calculating a first alpha value for a first particular period of time;
calculating a second alpha value for a second particular period of time, wherein the first alpha value is used in calculating the second alpha value; and
comparing the second alpha value to the predetermined alpha threshold value to detect the type of overload condition in the compiler module.

17. The method of claim 12, wherein the compiler module comprises a just-in-time compiler, wherein the buffer comprises a method-compilation cache stored in a dynamic heap memory.

18. A computer-readable medium storing computer-executable instructions for performing a method comprising:
(a) monitoring particular method calls associated with a buffer in a compiler module to identify an overload condition;
(b) detecting a type of overload condition in the compiler module;
(c) increasing size of the buffer if the type of overload condition in the compiler module corresponds to a performance-critical overload condition;
(d) decreasing size of the buffer if the type of overload condition in the compiler module corresponds to a no overload condition; and
(e) not changing size of the buffer if the type of overload condition in the compiler module corresponds to the non-performance-critical overload condition.

19. The computer-readable medium of claim 18, wherein (b) uses an alpha-count mechanism to detect the type of overload condition in the compiler module.

20. The computer-readable medium of claim 18, wherein the buffer comprises a method-compilation cache, and wherein the particular method calls monitored comprise a request to add a method to the buffer and a request to remove a method from the buffer.

21. A method of dynamically allocating size of a buffer in a mobile terminal, comprising:
(a) monitoring an effective run-time behavior of an application running on the mobile terminal; and
(b) adjusting the size of the buffer in the mobile terminal based on (a), wherein the buffer caches compiled native machine code.

22. The method of claim 21, wherein the effective run-time behavior comprises a request to add information to the buffer and a request to remove information from the buffer, wherein the buffer comprises a method-compilation cache.

23. The method of claim 21, wherein (a) comprises:
detecting a type of overload condition in the buffer using a count-and-threshold mechanism;

24. The method of claim 23, wherein (b) comprises:
increasing the size of the buffer in the mobile terminal if the type of overload condition corresponds to the performance-critical overload condition;
decreasing the size of the buffer in the mobile terminal if the type of overload condition corresponds to the no overload condition; and
not changing the size of the buffer in the mobile terminal if the type of overload condition corresponds to the non-performance-critical overload condition.

25. A device configured to dynamically adjust size of a buffer, comprising:
a memory unit, comprising:
compiler module including a buffer;
means for monitoring for an overload condition in the compiler module;
means for determining type of overload condition in the compiler module based at least in part on information from the buffer monitor module; and
means for dynamically adjusting size of the buffer in the compiler module based at least in part on information from the overload detector module; and
a processor coupled to the memory unit and programmed with at least the compiler module, the buffer monitor module, the overload detector module, and the buffer shaper module.

26. The device of claim 25, wherein the compiler module comprises a just-in-time compiler, and wherein at least part of the buffer is stored in a dynamic heap memory.

27. The device of claim 25, wherein the means for determining type of overload condition comprises an alpha-count mechanism that detects a non-performance-critical overload condition in the compiler module.
